(19) United States
(12) Patent Application Publication
(10) Pub. No.: US 2004/0079840 A1
(43) Pub. Date: Apr. 29, 2004

(54) Aircraft lift control system

(76) Inventors: William D. Armstrong, Laramie, WY (US); William R. Lindberg, Laramie, WY (US); Jonathan W. Naughton, Laramie, WY (US); John E. McInroy, Laramie, WY (US)

Correspondence Address: EMERY L. TRACY, P.O. Box 1518, Boulder, CO, 80306, US

(21) Appl. No.: 10/674,367

(22) Filed: Sep. 30, 2003

Related U.S. Application Data
(60) Provisional application No. 60/415,206, filed on Oct. 1, 2002.

(51) Int. Cl. B64C 3/00; B64C 5/00

(52) U.S. Cl. 244/198

(57) ABSTRACT

An aircraft lift control system mounted on an aircraft is provided. The aircraft has at least one wing. The aircraft lift control system comprises an oscillating aero surface mounted to the aircraft wing. A resonant frame is connected to the oscillating aero surface. An actuator is mounted to the resonant frame wherein the sinusoidal force produced by the actuator on the resonant frame results in a resonant deformation in the resonant frame and resonant-sinusoidal displacement of the aero-surface.

The present application is a continuation and claims priority of pending provisional patent application Serial No. 60/415,20, filed on Oct. 1, 2002, entitled “Aircraft Lift Control System”.

### BACKGROUND OF THE INVENTION

1. Field of the Invention

This invention relates generally to an aircraft lift control system and, more particularly, the invention relates to an aircraft lift control system having cooperative, high frequency, and dynamic-resonant aero-effectors.

2. Description of the Prior Art

Conventional active vibration control and flutter suppression systems are servo-hydraulic. Conventional servo-hydraulic technology is burdened by a set of undesirable characteristics which effectively restrict their use to large aircraft. The servo-hydraulic based systems have multiple critical parts are therefore susceptible to multiple point failures. The hydraulic servo valves, pumps, and pipe networks are very heavy. The compressibility of the hydraulic fluid, viscous losses in the moving hydraulic fluid and bandwidth limitations in the servo valves themselves limit these systems to relatively low frequency applications.

Accordingly, there exists a need for a high frequency bandwidth lift control for aircraft and other vehicles. In fact, a high frequency bandwidth lift control is of great practical importance for many civilian and military vehicles. For example, aircraft with stores, Uninhabited Air Vehicles (UAVs), and cruise missiles are all adversely affected by a lift driven divergent vibration response called flutter. Although lift control systems presently exist (e.g., servo-hydraulic systems and active structural components), these systems all have some limitations. The ideal lift control system, as disclosed by the present invention, would be small, lightweight, have fast response, consume little energy, and be transparent when not in use. Without such systems as described herein, some vehicles prone to flutter, such as high-altitude, long-endurance UAVs are seriously limited in their capabilities.

### SUMMARY

The present invention is an aircraft lift control system mounted on an aircraft. The aircraft has at least one wing. The aircraft lift control system comprises an oscillating aero surface mounted to the aircraft wing. A resonant frame is connected to the oscillating aero surface. An actuator is mounted to the resonant frame wherein the sinusoidal force produced by the actuator on the resonant frame results in a resonant deformation in the resonant frame and resonant-sinusoidal displacement of the aero-surface.

The present invention further includes a method for controlling aircraft lift. The aircraft has at least one wing. The method comprising comprises mounting an oscillating aero surface to the aircraft wing, connecting a resonant frame to the oscillating aero surface, mounting an actuator to the resonant frame, and producing a sinusoidal force on the resonant frame resulting in a resonant deformation in the resonant frame and resonant-sinusoidal displacement of the aero-surface.

### BRIEF DESCRIPTION OF THE DRAWINGS

FIG. 1 a is a perspective view illustrating a high frequency, dynamic-resonant aero-effector where motive force from the voice coil actuator is applied parallel to the motion of the aero-surface, constructed in accordance with the present invention;

FIG. 2 is a perspective view illustrating a high frequency, dynamic-resonant aero-effector where motive force from the voice coil actuator is applied transverse to the motion of the aero-surface, constructed in accordance with the present invention;

FIG. 3 is a photograph showing the high frequency, dynamic-resonant aero-effector of FIG. 2;

FIG. 4 is a perspective view illustrating the high frequency, dynamic-resonant aero-effector, constructed in accordance with the present invention, mounted in an aircraft wing; and

FIG. 5 is a perspective view illustrating the high bandwidth lift control system, constructed in accordance with the present invention, with two cooperative high frequency dynamic-resonant aero-effectors mounted in a short section of a wing.

### DETAILED DESCRIPTION OF THE PREFERRED EMBODIMENTS

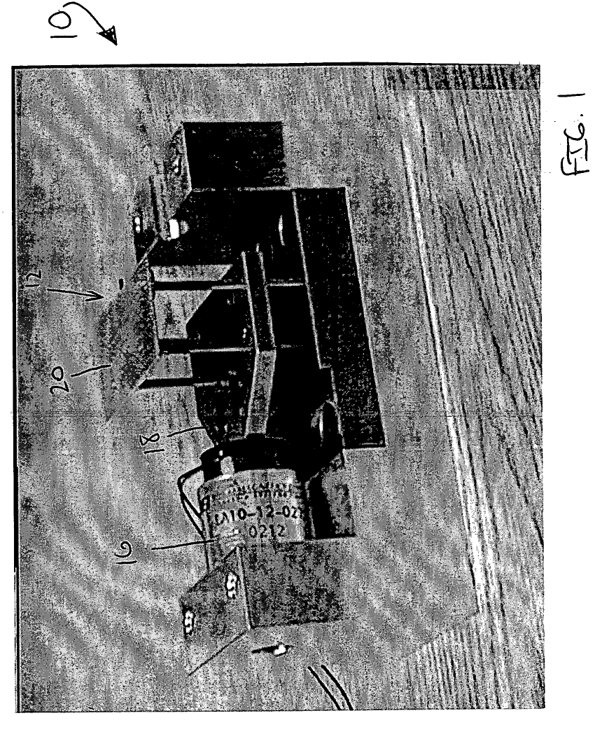

As illustrated in FIGS. 1, 2, and 3, the present invention is an active lift control system, indicated generally at 10. The technology of the active lift control system 10 of the present invention is based on a set of cooperative high-frequency dynamic-resonant aero-effectors 12. The dynamic-resonant aero-effectors 12 work together to dynamically modify the pressure distribution over an aero-surface 14 to rapidly change the time average lift and moment coefficients of the aero-surface 14. The high frequency bandwidth of actuators 16 allow the actuators 16 to control rapid fluid-structure interactions such as flutter and to impose very rapid maneuvering loads on an airframe without causing structural overloads. The active lift control system 10 of the present invention will, therefore, result in higher safety margins and/or lower structural weights, thereby increasing aircraft payload and/or operational limits (range, altitude, etc.).

FIG. 1 illustrates the active lift control system 10 of the present invention includes the high frequency, dynamic-resonant aero-effector 12. The dynamic-resonant aero-effector 12 is composed of three main components: an actuator 16, a resonant frame 18, and an oscillating aero surface 20. In an embodiment of the present invention, the actuator 16 is a linear voice coil actuator. It should be note, however, that while the active lift control system 10 of the present invention has been described as using a linear voice coil actuator, using any type of linear or rotary actuator of electromagnetic or piezoelectric origin is within the scope of the present invention. Furthermore, preferably, the oscillating aero-surface 20 has a width of approximately two (2″) inches and a length of approximately one (1″) inch, operating at a frequency of approximately 1890 Hz. While the present invention operates at approximately 72 Hz, it should be noted, however, that the oscillating aero-surface 20 can have a width of greater than or less than approximately two (2″) inches, a length greater than or less than approximately one (1″) inch, and operate at a frequency of greater than or less than approximately 1890 Hz. The small sinusoidal force developed by the voice coil effector on the middle mass results in a resonant deformation in the device columns and large resonant-sinusoidal displacement of the aero-surface 14.

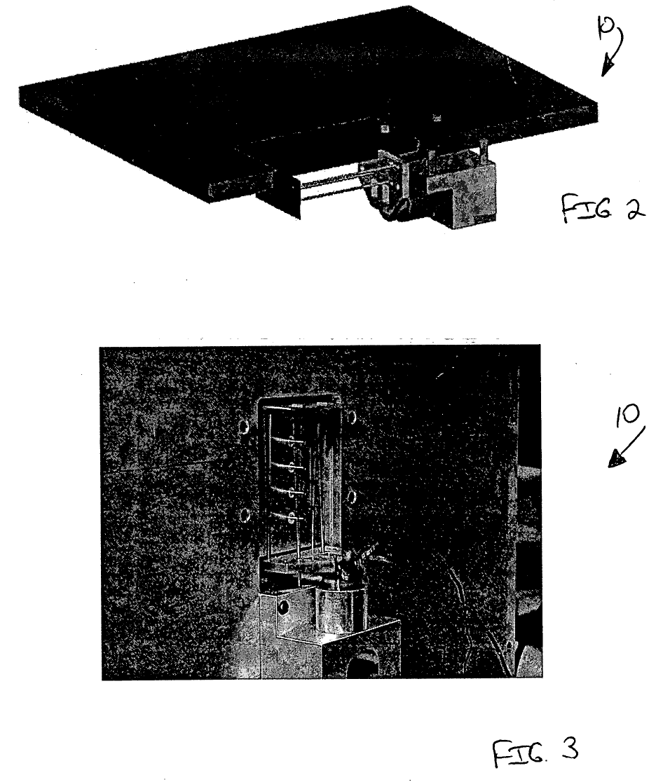

FIG. 2 illustrates a high frequency, dynamic-resonant aero-effector 12 design where the motive force from the voice coil actuator is applied transverse to the motion of the aero-surface 14. In this embodiment, the small sinusoidal force developed by the voice coil effector on the middle mass results in a resonant rocking motion of the central mass, large resonant deformation of the device columns, and consequently large resonant-sinusoidal displacement of the aero-surface 14.

FIG. 3 illustrates the transverse high frequency, dynamic-resonant aero-effector 12 of the present invention. The five small cylindrical features are pressure taps mounted in a cover for use in the wind tunnel.

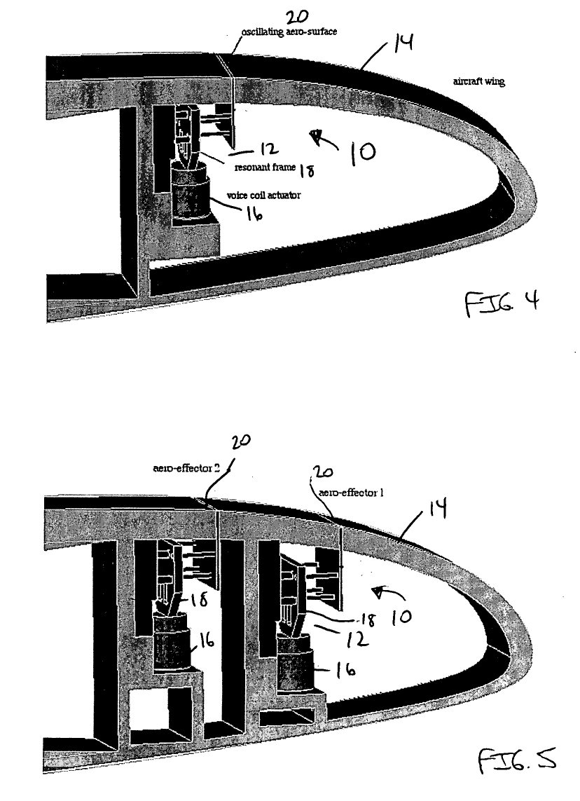

FIG. 4 illustrates the high frequency, dynamic-resonant aero-effector 12 installed in an aircraft wing. The top of the oscillating aero-surface 20 fits flush with the upper surface of the wing when the actuator 16 is unpowered. An acoustic frequency alternating current is transmitted through the voice coil device to produce a force which varies sinusoidally in time. The frequency of the voice coil alternating current is preferably selected to match the elastic resonance frequency of the resonant frame and oscillating aero-surface mass-spring system. This results in large amplitude oscillatory motion of the aero-surface 14 perpendicular to the wing surface. The top portion of oscillating aero-surface 20, therefore, cyclically projects into the air flowing over the top surface of the wing. The projected aero-surface 20 disturbs the smooth flow over the wing, causing local flow separation and vortex structures. These flow structures reduce the vacuum pressure at local points on the wing resulting in a change in the coefficient of lift which can be used to maneuver the aircraft or to suppress aerodynamic flutter. Switching off power to the device returns the top of the oscillating aero-surface 20 to a position flush with the upper wing surface.

Practical lift control systems of the present invention are composed of two or more aero-effectors operated cooperatively. FIG. 5 illustrates an example high bandwidth lift control system 10 composed of two cooperative high frequency dynamic-resonant aero-effectors 12 mounted in a section of a wing. The individual operation of each device 12 is the same as previously described, however, the specific displacement, phase relationship, and operation frequency of the second device is selected to amplify the lift modification effects of the first device 12. A large number of small-scale devices 12 could be combined in this manner. A wave-like flow disturbance structure originates at the first device 12 and then very rapidly grows as subsequent effectors 12 cause flow disturbance resonance. The attenuation of the lift effects would follow a similar spatial-time pattern. The cyclic displacement of each of the aero-effector devices 12 would be actively canceled resulting in a return to smooth flow over the wing.

The present invention leads to structural weight reductions on high performance unmanned air vehicles, as flutter divergence would be actively controlled. Presently, these aircraft must be over-built to protect against flutter which results in a significant weight increase. The present invention could also be used for cruise missiles and possibly high performance, light civilian jet aircraft. Since divergent flutter vibration often leads to the destruction of an aircraft, the present invention suppresses the divergent flutter vibration with minimal system weight and power demands.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the

What is claimed is:

1. An aircraft lift control system mounted on an aircraft, the aircraft having at least one wing, the aircraft lift control system comprising:
an oscillating aero surface mounted to the aircraft wing;
a resonant frame connected to the oscillating aero surface; and
an actuator mounted to the resonant frame;
wherein the sinusoidal force produced by the actuator on the resonant frame results in a resonant deformation in the resonant frame and resonant-sinusoidal displacement of the aero-surface.

2. The aircraft lift control system of claim 1 wherein the oscillating aero-surface has a width of approximately two (2″) inches and a length of approximately one (1″) inch, operating at a frequency of approximately 1890 Hz.

3. The aircraft lift control system of claim 1 wherein the oscillating aero-surface operates at a frequency of less than approximately 1000 Hz.

4. The aircraft lift control system of claim 1 wherein the actuator is a linear voice coil actuator.

5. The aircraft lift control system of claim 1 wherein the motive force from the actuator is applied transverse to the motion of the aero-surface such that the sinusoidal force developed by the actuator on the resonant frame results in a resonant rocking motion of the resonant frame, resonant deformation of the columns, and resonant-sinusoidal displacement of the aero-surface.

6. The aircraft lift control system of claim 1 wherein the aero surface is mounted flush with an upper surface of the aircraft when the actuator is unpowered.

7. The aircraft lift control system of claim 6 wherein acoustic frequency alternating current is transmitted through the voice coil device producing a force, the force varying sinusoidally in time.

8. The aircraft lift control system of claim 7 wherein the frequency of the voice coil alternating current matches the elastic resonance frequency of the resonant frame and oscillating aero-surface mass-spring system thereby resulting in amplitude oscillatory motion of the aero-surface perpendicular to the aircraft wing surface.

9. The aircraft lift control system of claim 8 wherein the top portion of the oscillating aero-surface cyclically projects into the air flowing over the top surface of the wing thereby disturbing the smooth flow over the wing causing local flow separation and vortex structures.

10. The aircraft lift control system of claim 9 wherein the system reduces the vacuum pressure at local points on the wing resulting in a change in the coefficient of lift and change in the pressure moment about the wing which can be used to maneuver the aircraft or to suppress aerodynamic flutter.

11. The aircraft lift control system of claim 6 wherein the oscillating aero-surface returns to a position flush with the upper wing surface upon depowering.

12. The aircraft lift control system of claim 1 and further comprising:
two or more systems within the aircraft wing.

13. The aircraft lift control system of claim 12 wherein each system is operated independently of the other systems with specific displacement, phase relationship, and operation frequency of the second device is selected to amplify the lift modification effects of the first device.

14. The aircraft lift control system of claim 13 wherein a wave-like flow disturbance structure originates at a first device and grows as subsequent effectors cause flow disturbance resonance and the attenuation of the lift effects follows a similar spatial-time pattern with the cyclic displacement of each of the aero-effector devices being actively canceled resulting in a return to smooth flow over the wing.

15. The aircraft lift control system of claim 1 wherein the frequency of resonant oscillation is alterable by changes in the resonant frame stiffness of mass distribution.

16. The aircraft lift control system of claim 1 wherein the aero surface is driven through complex displacement waveforms selected from the group consisting of triangular, squarewaves and triangular, and squarewave with partial duty cycles.

17. A method for controlling aircraft lift, the aircraft having at least one wing, the method comprising:
mounting an oscillating aero surface to the aircraft wing;
connecting a resonant frame to the oscillating aero surface;
mounting an actuator to the resonant frame; and
producing a sinusoidal force on the resonant frame resulting in a resonant deformation in the resonant frame and resonant-sinusoidal displacement of the aero-surface.

18. The method of claim 17 wherein the actuator is a linear voice coil actuator.

19. The method of claim 17 and further comprising:
applying transverse to the motion of the aero-surface such that the sinusoidal force developed by the actuator on the resonant frame results in a resonant rocking motion of the resonant frame, resonant deformation of the columns, and resonant-sinusoidal displacement of the aero-surface.

20. The method of claim 17 and further comprising:
mounting the aero surface flush with an upper surface of the aircraft when the actuator is unpowered.

21. The method of claim 20 and further comprising:
transmitting acoustic frequency alternating current through the voice coil device; and
producing a force, the force varying sinusoidally in time.

22. The method of claim 21 and further comprising:
matching the frequency of the voice coil alternating current with the elastic resonance frequency of the resonant frame and oscillating aero-surface mass-spring system thereby resulting in amplitude oscillatory motion of the aero-surface perpendicular to the aircraft wing surface.

23. The method of claim 22 and further comprising:
projecting the top portion of the oscillating aero-surface cyclically into the air flowing over the top surface of the wing; and
disturbing the smooth flow over the wing causing local flow separation and vortex structures.

24. The method of claim 23 and further comprising:
reducing the vacuum pressure at local points on the wing; and
changing the coefficient of lift which can be used to maneuver the aircraft or to suppress aerodynamic flutter.

25. The method of claim 20 and further comprising:
returning the oscillating aero-surface to a position flush with the upper wing surface upon depowering.

26. The method of claim 17 and further comprising:
providing two or more systems within the aircraft wing.

27. The method of claim 26 and further comprising:
operating each system independently of the other systems with specific displacement, phase relationship, and operation frequency of the second device is selected to amplify the lift modification effects of the first device.

28. The method of claim 27 and further comprising:
originating a wave-like flow disturbance structure at a first device;
increasing the disturbance as subsequent effectors cause flow disturbance resonance and the attenuation of the lift effects follows a similar spatial-time pattern with the cyclic displacement of each of the aero-effector devices being actively canceled resulting in a return to smooth flow over the wing.
